(19) United States
(12) Patent Application Publication
(10) Pub. No.: US 2026/0170381 A1
(43) Pub. Date: Jun. 18, 2026

(54) USING QUANTUM STATE ESTIMATION TO ENABLE MEASUREMENT-BASED OPITCAL COMPUTATION AT THE FEW PHOTON LEVEL

(71) Applicant: NTT RESEARCH, INC., Sunnyvale, CA (US)

(72) Inventors: Edwin NG, SUNNYVALE, CA (US); Yoshitaka iNUI, SUNNYVALE, CA (US); Yoshihisa YAMAMOTO, SUNNYVALE, CA (US)

(73) Assignee: NTT RESEARCH, INC., Sunnyvale, CA (US)

(21) Appl. No.: 19/123,630

(22) PCT Filed: Oct. 24, 2023
(86) PCT No.: PCT/US2023/035835

§ 371 Date: Apr. 23, 2025

Related U.S. Application Data
(60) Provisional application No. 63/418,672, filed on Oct. 24, 2022.

(51) Int. Cl. G06N 10/40; G06N 7/01

(52) U.S. Cl. CPC G06N 10/40; G06N 7/01

(57) ABSTRACT

A coherent Ising machine may include a process cavity configured to maintain a system state in a low photon regime. The coherent Ising machine may further include a controller configured to estimate the system state based on a previous iteration, measure the system state, determine a quantum noise in the process cavity based on comparing the estimated system state and the measured system state, calculate a feedback based on the estimated system state and the quantum noise, and provide the feedback to the process cavity for a next iteration.

### CROSS REFERENCE TO RELATED APPLICATIONS

This application claims priority to U.S. Provisional Application No. 63/418,672 filed Oct. 24, 2022, which has been incorporated by reference in its entirety.

### FIELD

This disclosure relates to low energy coherent Ising machines that can operate at low or few photon regimes.

### BACKGROUND

Coherent Ising machines (CIMs) can be used to solve for combinatorial optimizations. For example, a combinatorial optimization problem may be mapped to an Ising problem. Generally speaking, the Ising problem may be representation of an energy state of a physical system having a combination of multiple controllable entities that contribute to the energy state. For instance, an Ising problem may include a combination of electron spins, and the combination providing the lowest energy state may form the solution of the Ising problem. Such combination is therefore the solution to the combinatorial optimization problem.

A CIM generally is made of two components: a physical component that represents a current state of the combination (e.g., combination of spins) and a feedback component that reads the current state and applies feedback to move the current state in a desired path (i.e., to find a combination with the lowest energy state). The physical component may be formed by one or more optical cavities that hold the current state in one or more light pulses. The feedback component may be formed by electronic components that interact with the physical component. This organization of CIM may solve combinatorial optimization problems significantly faster than conventional digital computers—it is well known in the art that digital computers are inefficient in solving NP-hard problems such as combinatorial optimization problems.

While CIMs are significantly faster than conventional digital computers, there is a desire is to make CIMs more energy efficient. There is a particular desire for reducing energy consumption by the physical component of the CIM.

### SUMMARY

In some embodiments, a coherent Ising machine may be provided. The coherent Ising machine may include a process cavity configured to maintain a system state in a low photon regime. The coherent Ising machine may further include a controller configured to estimate the system state based on a previous iteration, measure the system state, determine a quantum noise in the process cavity based on comparing the estimated system state and the measured system state, calculate a feedback based on the estimated system state and the quantum noise, and provide the feedback to the process cavity for a next iteration.

In some embodiments, a method may be provided. The method may include maintaining, by a process cavity of a coherent Ising machine, a system state in a low photon regime. The method may also include estimating, by a controller of the coherent Ising machine, the system state based on a previous iteration. The method may further include measuring, by the controller, the system state. The method may further include determining, by the controller, a quantum noise in the process cavity based on comparing the estimated system state and the measured system state. The method may further include calculating, by the controller, a feedback based on the estimated system state and the quantum noise. The method may additionally include providing, by the controller, the feedback to the process cavity for a next iteration.

### BRIEF DESCRIPTION OF DRAWINGS

FIG. 1 shows an example CIM according to example embodiments of this disclosure.

FIG. 2 is a flowchart of an example method for executed by a CIM, according to example embodiments of this disclosure.

### DESCRIPTION

A conventional CIM generally works in a high-energy limit in which there are many photons per optical mode, e.g., many photons may represent a system state. For such many-photon regimes, measurement and feedback are easy and effective because of the inherent high signal to noise ratio (SNR). For example, a field programmable gate array (FPGA) or an electronic controller can be used for a flexible control of the optical part, while taking advantage of the high SNR. However, for the optical component to consume less power, the number of photons per mode may have to be reduced, which causes a concomitant reduction in the SNR. Therefore, a low SNR—which was not a concern in the many-photon regime—becomes a bottleneck when the power is reduced.

Embodiments disclosed herein provide coherent Ising machines (CIMs) that may have lower power consumption compared to conventional CIMs, while addressing the low SNR bottleneck. Although an individual measurement of the optical component may have low SNR and is therefore noisy, a historical data of the measurements may be used to estimate the individual measurement, and the estimated measurement may be compared with the actual, noisy measurement. That is, a high-precision estimate of the system state—within the optical component—may be obtained through a collective decision making over a longer time horizon even when an individual state is noisily observed.

Such longer time horizon estimation may be based on knowing an initial system state, the noise profile (e.g., a quantum noise) of the optical component, and the deterministic feedback provided to the optical component. In the embodiments where the optical component is linear, the estimation may be analogous to running a Kalman filter on the measured system state with the quantum noise. In the embodiments where the optical component is nonlinear, a Gaussian model may be used for nonlinear state estimation based on simulating the Gaussian model. The Gaussian model assumption may be broken for optical components behaving in non-Gaussian regime. For the non-Gaussian regime, approximate Gaussian model may be used.

Embodiments disclosed herein further allow a flexibility for a time-energy tradeoff. For computations that are time-sensitive without requiring energy optimization, the CIM can be configured to operate at a higher photon regime for quicker computation, e.g., by having no overhead of the different estimations. However, for computations that are not time-sensitive, a lower photon regime may be used to generate the results in a longer time horizon.

Embodiments disclosed herein may further be used for extracting information about a state of low energy optical system through successive measurements, such as in ring-down spectroscopy or detecting a force. That is, if the behavior of the CIM deviates from an estimated quantum noise behavior, such deviation may be picking up a measurement (e.g., a force) in the vicinity. The deviation may then be quantified to determined as a measured quantity (e.g., of the force).

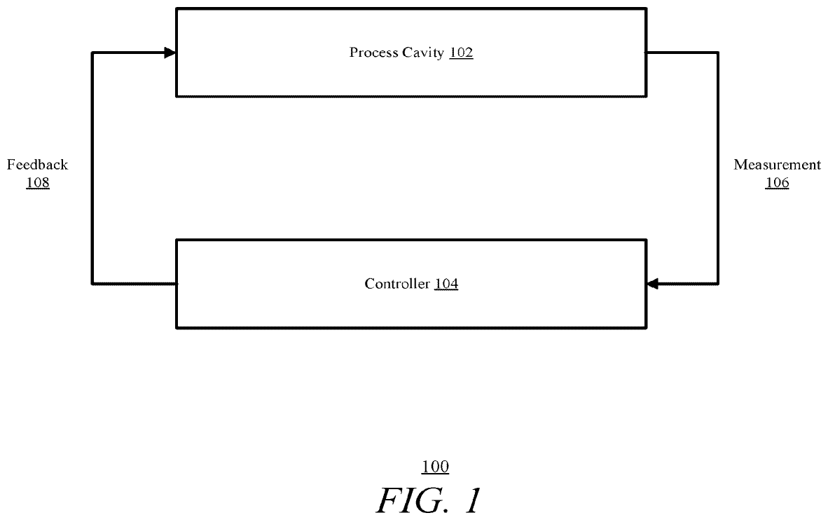

FIG. 1 shows an example CIM 100 according to example embodiments of this disclosure. As shown, the CIM 100 may include a process cavity 102 and a controller 104. In some embodiments, the process cavity 102 may include a set physical set of oscillators that represent spins of the Ising problem (e.g., a combinatorial optimization program). The process cavity 102 may function as a memory—e.g., by storing the spins—and also can take advantage of hardware-level details such as clock rate, parallelization, and energy efficiency. The controller 104 may estimate the state of the process cavity 102 and apply feedback in order to realize desired overall dynamics. The controller 104 may apply a sophisticated control scheme such as Ising couplings and/or Zeeman biases, time-dependent parameters, or destabilization of local optimization traps (e.g., chaotic amplitude control), etc. Generally, the controller 104 may be formed by an FPGA and/or a digital computer.

Embodiments disclosed herein are directed to minimize the energy consumption by the CIM 100. The energy consumption may be in the form of energy contained within the process cavity 102, energy expended for measurement 106, energy expended for feedback 108, energy expended by the controller 104 to calculate the feedback 108, and auxiliary energy consumption for stabilization, synchronization, signal amplification, etc. Generally, the measurement 106 and the feedback 108 resembles a communication problem between the state of the process cavity 102 and the external controller 104.

Classically, i.e., without the quantum effects, the CIM 100 may be described by a set of N differential equations. A single differential equation for instance i may be:

$$\frac{d {x}_{i}}{d t} = - γ {x}_{i} + p {x}_{i} - χ {x}_{i}^{3} - λ {\sum }_{j = 1}^{N} {J}_{ij} {x}_{j} ,$$

where xᵢ may be a spin, p may be a pump rate, γ may be a loss rate, χ may be a nonlinear loss rate, and λ may be the coupling rate. All of the parameters p, γ, χ, λ may be time dependent. In some embodiments, such as for controlling the evolution of xᵢ, p and λ may be chosen. One example of time dependence of λ may be chosen as λ=eᵢ(t) for an auxiliary variable eᵢ(t) that obeys the following differential equation:

$$\frac{d {e}_{i}}{d t} = - β ( {x}_{i}^{2} - {μ}^{2} )$$

Using this auxiliary variable eᵢ(t), the CIM 100 may be constructed to have a chaotic amplitude control. The chaotic amplitude control may cause the CIM 100 to avoid from settling at a local minima. Accordingly, in the above differential equation for the auxiliary variable eᵢ(t), μ (which may be taken as positive without loss of generality) may be target amplitude and β may be a gain rate setting the strength of the feedback 108.

The principle of operation of the CIM 100 using the above differential equations can first be described based on classical mechanics, and without the quantum effects. That is, the first differential equation forms an equation of motion based on classical dynamical-systems theory and the second differential equation is based on classical control theory applied as a control feedback 108 (as shown, a nonlinear control feedback 108 because of the chaotic amplitude control) to the equation of motion. However, the CIM 100's dynamic behavior may obey the above equations only within an appropriate physical regime or limit. In other words, the CIM 100's dynamic behavior to obey the equations of motion is a subset of the degrees of freedom—that may define the entire range of behavior—of the CIM 100. The degrees of freedom may therefore have to be bounded—using the physical regime or limit—to physically realize the CIM 100. From this assumption, three facts may logically follow: (1) the physical CIM 100 may be a generalization of the classical formulation, in that a physical system such as the physical CIM 100 must have additional degrees of freedom than those strictly required to implement the above described dynamic behavior, (2) certain physical regimes or limits may have to be specified to reduce the behavior of the CIM 100 (i.e., bound the degrees of freedom) to a form to identify the CIM 100 with the classical formulation, and (3) even after the behavior reduction, the CIM 100 may include additional details, inherent to the physics of the CIM 100, which may have to be analyzed how the additional details cause the CIM 100 to differ—beneficially or detrimentally—from the classical formulation. For instance, if the CIM 100 is operated in a physical regime where quantum noise is inescapable, the nature of the quantum noise may have to be understood, and this understanding may have to be used to augment the classical formulation to operate the CIM 100.

Generally, to realize the CIM 100 as a physical system that obeys certain equations of motion, the actual physical behavior of the process cavity 102 may have to be reduced toward the equations of motion. Additionally, real-world noise may be experienced by the process cavity 102 may have to be considered.

In some embodiments, the process cavity 102—forming the physical system—may include N optical oscillators. The variables xᵢ may be encoded in the real quadrature of the N optical oscillators. In some embodiments, the N optical oscillators may include degenerate optical parametric oscillators (DOPOs). The DOPOs may possesses background losses consistent with the loss rate γ. The gain β and nonlinear terms (e.g., loss rate χ) may be realized by pumping a corresponding DOPO to generate parametric gain within the DOPO (implementing the gain β), which then may also exhibit nonlinear saturation due to pump depletion thereby implementing the nonlinear terms.

The coupling term

$$λ {\sum }_{j = 1}^{N} {J}_{ij} {x}_{j}$$

may be realized through a three-step process. First the real quadratures of the optical oscillators may be measured using balanced homodyne detection. Second, the N measured values are multiplied by the coupling matrix J to calculate, on the controller 104, the coupling term

$$λ {\sum }_{j = 1}^{N} {J}_{ij} {x}_{j} .$$

Third, the coupling term may be re-encoded back into the optical domain using modulators and then injected (i.e., through the feedback 108) into each respective optical oscillator within the process cavity 102.

The auxiliary variables eᵢ may be stored in the controller 104. Additionally, the controller 104 may generate the dynamics described above to realize the chaotic amplitude control, by using the measured values of the real quadrature described above. A current value of eᵢ(t) may then be used as a multiplicative factor when computing the feedback injection. The CIM 100 therefore becomes a measurement-feedback based CIM, often abbreviated as MFB-CIM.

In some embodiments, the CIM 100 may be described using the language of quantum optics. Particularly, the optical oscillators within the process cavity 102 may be identified with N signal mode operators âᵢ obeying:

$$[ {\hat{a}}_{i} , {\hat{a}}_{j}^{†} ] = {δ}_{i j}$$

Then, the real and imaginary quadrature operators may be defined, respectively, as follows:

$${\hat{q}}_{i} : = \frac{1}{\sqrt{2}} ( {\hat{a}}_{i} + {\hat{a}}_{i}^{†} )$$

$${\hat{p}}_{i} : = \frac{1}{\sqrt{2} i} ( {\hat{a}}_{i} - {\hat{a}}_{i}^{†} )$$

In the above formalism, each of the elements of the CIM 100 (e.g., background loss, gain, nonlinearity, measurement, injection, etc.) may be described in a quantum mechanical manner. In some embodiments, the CIM 100 quantum system may remain in a Gaussian state throughout the operation of the CIM 100. The Gaussian state may be applicable because, for a majority of physical systems (e.g., CIM 100), optical nonlinearities may be usually weak and the background loss and measurements tend to project the quantum state toward Gaussian states, even as the physical systems undergo nonlinear evolution.

In the Gaussian state model, the quantum state of the CIM 100 may be represented by a set of N means:

$$〈 {\hat{q}}_{i} 〉$$

and variances:

$$〈 δ {\hat{q}}_{i}^{2} 〉 ,$$

$$〈 δ {\hat{p}}_{i}^{2} 〉$$

That is, the total number of variables may be N+N+N=3N. An additional technical assumption of:

$$〈 \{ δ \hat{q} , δ \hat{p} \} 〉 = 0$$

The technical assumption may be valid because CIM 100 may not introduce mixing between the real and imaginary quadratures.

Using the Gaussian model, the CIM 100 may evolve according to a sequence of discrete operations, corresponding to: (1) linear loss, (2) nonlinear propagation, (3) homodyne measurement, and (4) feedback injection. In the CIM 100, the index i may be physically uncoupled for all operations below, so the indexing is not reproduced for all the expressions below for the sake of brevity. However, all of the operations below may be performed N times, once for each i.

(1) Linear Loss: The basic parameter for the linear loss operation may be Rₗₒₛₛ, the energy loss ratio. In the Gaussian formalism, the operation may be described by:

$$〈 \hat{q} 〉 ↦ \sqrt{1 - {R}_{l o s s}} 〈 \hat{q} 〉 ,$$

$$〈 δ {\hat{q}}^{2} 〉 ↦ ( 1 - {R}_{l o s s} ) 〈 δ {\hat{q}}^{2} 〉 + \frac{1}{2} {R}_{l oss} ,$$

$$〈 δ {\hat{p}}^{2} 〉 ↦ ( 1 - {R}_{l o s s} ) 〈 δ {\hat{p}}^{2} 〉 + \frac{1}{2} {R}_{l o s s} .$$

By convention, the linear loss operation may be applied twice in one roundtrip, once before nonlinear propagation and once after the nonlinear propagation. So the total amount of loss in the system may be given by:

$$1 - {( 1 - {R}_{l o s s} )}^{2}$$

(2) Nonlinear Propagation: Nonlinear propagation through the crystals in the process cavity 102 may be characterized by three parameters: the nonlinear rate ϵ inside a crystal, the time τₙₗ over which the propagation occurs, and (3) the pump field amplitude αₚᵤₘₚ CO-propagating with the system. A Gaussian quantum model for this system may be obtained by integrating the following differential equations over the propagation time τₙₗ.

$$\begin{matrix}{\partial }_{∈ τ} 〈 \hat{x} 〉 = 〈 \hat{u} 〉 〈 \hat{x} 〉 + ( 〈 δ \hat{x} δ \hat{u} 〉 + 〈 δ \hat{y} δ \hat{u} 〉 ) , & {\partial }_{∈ τ} 〈 \hat{u} 〉 = - \frac{1}{2} {〈 \hat{x} 〉}^{2} - \frac{1}{2} ( 〈 δ {\hat{x}}^{2} 〉 - 〈 δ {\hat{y}}^{2} 〉 ) , \\ {\partial }_{∈ τ} 〈 δ {\hat{x}}^{2} 〉 = 2 〈 \hat{u} 〉 〈 δ {\hat{x}}^{2} 〉 + 2 〈 \hat{x} 〉 〈 δ \hat{x} δ \hat{u} 〉 , & {\partial }_{∈ τ} 〈 δ {\hat{y}}^{2} 〉 = - 2 〈 \hat{u} 〉 〈 δ {\hat{y}}^{2} 〉 + 2 〈 \hat{x} 〉 〈 δ \hat{y} δ \hat{v} 〉 , \\ {\partial }_{∈ τ} 〈 δ {\hat{u}}^{2} 〉 = - 2 〈 \hat{x} 〉 〈 δ \hat{x} δ \hat{u} 〉 , & {\partial }_{∈ τ} 〈 δ {\hat{v}}^{2} 〉 = - 2 〈 \hat{x} 〉 〈 δ \hat{y} δ \hat{v} 〉 , \\ {\partial }_{∈ τ} 〈 δ \hat{x} δ \hat{u} 〉 = 〈 \hat{x} 〉 ( 〈 δ {\hat{u}}^{2} 〉 - 〈 δ {\hat{x}}^{2} 〉 ) + 〈 \hat{u} 〉 〈 δ \hat{x} δ \hat{u} 〉 , & {\partial }_{∈ τ} 〈 δ \hat{y} δ \hat{v} 〉 = 〈 \hat{x} 〉 ( 〈 δ {\hat{v}}^{2} 〉 - 〈 δ {\hat{y}}^{2} 〉 ) - 〈 \hat{u} 〉 〈 δ \hat{y} δ \hat{v} 〉 .\end{matrix}$$

For convenience of notations, \hat{x} and ŷ have been introduced above such that:

$$\hat{a} = \hat{x} + i \hat{y}$$

### Therefore,

$$〈 \hat{q} 〉 = \sqrt{2} 〈 \hat{x} 〉$$

$$〈 δ {\hat{q}}^{2} 〉 = 2 〈 δ {\hat{x}}^{2} 〉$$

$$〈 δ {\hat{p}}^{2} 〉 = 2 〈 δ {\hat{y}}^{2} 〉$$

Additionally, new variables:

$$〈 \hat{u} 〉 ,$$

$$〈 δ {\hat{u}}^{2} 〉 ,$$

$$〈 δ {\hat{v}}^{2} 〉$$

have been introduced, and these variables may correspond to the Gaussian state of the pump with mode operator

$$\hat{b} = \hat{u} + i \hat{v}$$

There may also be covariances between the modes â and \hat{b}, represented by Gaussian moments [symbol] δ\hat{x}δû [symbol] , etc. The Gaussian moments may be necessary to describe the gain and nonlinear physical behavior that may arise from an interaction of the CIM 100 with corresponding pumps.

The initial conditions for the above system of equations may be given by:

$$\begin{matrix}〈 \hat{x} 〉 ( 0 ) = \sqrt{2} 〈 \hat{q} 〉 & 〈 \hat{u} 〉 ( 0 ) = {α}_{pump} \\ 〈 δ {\hat{x}}^{2} 〉 ( 0 ) = 2 〈 δ {\hat{q}}^{2} 〉 & 〈 δ {\hat{y}}^{2} 〉 ( 0 ) = 2 〈 δ {\hat{p}}^{2} 〉 \\ 〈 δ {\hat{u}}^{2} 〉 ( 0 ) = \frac{1}{4} & 〈 δ {\hat{v}}^{2} 〉 ( 0 ) = \frac{1}{4} \\ 〈 δ \hat{u} δ \hat{x} 〉 ( 0 ) = 0 & 〈 δ \hat{v} δ \hat{y} 〉 ( 0 ) = 0 ,\end{matrix}$$

where [symbol] \hat{q} [symbol] , [symbol] δ\hat{q}² [symbol] , and [symbol] δ\hat{p}² [symbol] may be the moments of the input Gaussian state of the CIM 100, produced by the previous operation.

With the above formulation—for instance, starting from deterministic initial conditions—the equations may be integrated numerically using an 8-dimensional ordinary differential equation solver. The final values of [symbol] \hat{x} [symbol] (τₙ₁), [symbol] δ\hat{x}² [symbol] (τₙ₁), and [symbol] δŷ² [symbol] (τₙ₁) may then be interpreted into the new values for [symbol] \hat{q} [symbol] , [symbol] δ\hat{q}² [symbol] , and [symbol] δ\hat{p}² [symbol] for the output Gaussian state. All other variables may be discarded, which may correspond to tracing the other variables out.

(3) Homodyne Measurement: The two parameters for homodyne measurement, e.g., by the controller 104 may include Rₒᵤₜ, the energy outcoupling ratio, and η, the anti-squeezing ratio of the measurement probe pulse. This discrete operation can be broken down into three steps: (i) outcoupling and the generation of entanglement between cavity pulse and probe pulse, (ii) measurement of the probe pulse, and (iii) backaction on the cavity pulse. After the outcoupling, the following evolution may be observed:

$$〈 \hat{q} 〉 ↦ \sqrt{1 - {R}_{o u t}} 〈 \hat{q} 〉 ,$$

$$〈 δ {\hat{q}}^{2} 〉 ↦ ( 1 - {R}_{o u t} ) 〈 δ {\hat{q}}^{2} 〉 + \frac{1}{2} η {R}_{o u t} ,$$

$$〈 δ {\hat{p}}^{2} 〉 ↦ ( 1 - {R}_{o u t} ) 〈 δ {\hat{p}}^{2} 〉 + \frac{1}{2} {η}^{- 1} {R}_{o u t}$$

In addition, the Gaussian state of cavity-probe system may have the following additional correlations:

$$〈 {\hat{q}}_{m} 〉 = \sqrt{{R}_{o u t}} 〈 \hat{q} 〉 ,$$

$$〈 δ {\hat{q}}_{m}^{2} 〉 = {R}_{o u t} 〈 {\hat{δ q}}^{2} 〉 + \frac{1}{2} η ( 1 - {R}_{o u t} ) ,$$

$$〈 δ \hat{q} δ {\hat{q}}_{m} 〉 = \sqrt{{R}_{o u t} ( 1 - {R}_{o u t} )} ( 〈 δ {\hat{q}}^{2} 〉 - \frac{1}{2} η ) .$$

As a measurement result, the measurement of the probe pulse may produce a random variable [symbol] :

$$w ∼ 𝒩 ( 〈 {\hat{q}}_{m} 〉 , \sqrt{〈 δ {\hat{q}}_{m}^{2} 〉} )$$

where [symbol] (μ, σ) may denote a normally distributed random number with mean μ and standard deviation σ. This measurement result may be stored into the controller 104 as a measurement record.

Finally, the backaction step may change the state of the process cavity 102 again, according to:

$$〈 \hat{q} 〉 ↦ 〈 \hat{q} 〉 + \frac{〈 δ \hat{q} δ {\hat{q}}_{m} 〉}{〈 δ {\hat{q}}_{m}^{2} 〉} ( w - 〈 {\hat{q}}_{m} 〉 ) ,$$

$$〈 δ {\hat{q}}^{2} 〉 ↦ 〈 δ {\hat{q}}^{2} 〉 - \frac{{〈 δ \hat{q} δ {\hat{q}}_{m} 〉}^{2}}{〈 δ {\hat{q}}_{m}^{2} 〉} .$$

(4) Feedback injection: After the measurement results are obtained, they may be processed by the controller 104 to generate a vector of feedback term fᵢ for each oscillator in the process cavity 102. However, the controller 104 may have obtained only noisy information about the system state of the process cavity 102 given by the random variable [symbol] . The below describes handling the noisy states, but to continue the current modeling, the controller 104 may compute a feedback 108 term f, which may be a single real number, based on the measurement 106 the controller 104 has obtained from the process cavity 102 and the calculations the controller 104 can perform. Additionally, f may include a result of tracking the auxiliary variable e and its evolution, which is further discussed below.

After the controller 104 computes f, the physical description of the feedback 108 to the process cavity 102 may be expressed as:

$$〈 \hat{q} 〉 ↦ 〈 \hat{q} 〉 + f .$$

The above description therefore discloses the four steps of discrete time Gaussian computations performed by the CIM 100. However, the equations of motions—the differential equations above—are inherently formulated in continuous time. To address this discrepancy, a continuous time limit of the discrete time Gaussian model may be taken. For that purpose, a new time scale Δt corresponding to the time it takes for the CIM 100 to complete a single roundtrip or iteration through the above described operations. As assumption may be made that:

$${R}_{loss} ∼ {R}_{out} ∼ {α}_{p}^{2} ∼ {( {ϵτ}_{nl} )}^{2} ∼ Δ t ∼ ϵ$$

where ε<<1 may be a small parameter such that the limit ε→0 may define a continuous time. Therefore, expanding the effects of the discrete operations to first order in & may allow taking a correct limit, as further described below.

Expanding to first order in ε and applying the below expression twice

$$〈 \hat{q} 〉 ↦ \sqrt{1 - {R}_{loss}} 〈 \hat{q} 〉 ,$$

$$〈 δ {\hat{q}}^{2} 〉 ↦ ( 1 - {R}_{loss} ) 〈 δ {\hat{q}}^{2} 〉 + \frac{1}{2} {R}_{loss} ,$$

$$〈 δ {\hat{p}}^{2} 〉 ↦ ( 1 - {R}_{loss} ) 〈 δ {\hat{p}}^{2} 〉 + \frac{1}{2} {R}_{loss} .$$

results in:

$$〈 \hat{q} 〉 ↦ ( 1 - {R}_{loss} ) 〈 \hat{q} 〉 + 𝒪 ( {ϵ}^{2} ) ,$$

$$〈 δ {\hat{q}}^{2} 〉 ↦ 〈 δ {\hat{q}}^{2} 〉 + {R}_{loss} ( 〈 δ {\hat{q}}^{2} 〉 - \frac{1}{2} )$$

$$〈 δ {\hat{p}}^{2} 〉 ↦ 〈 δ {\hat{p}}^{2} 〉 + {R}_{loss} ( 〈 δ {\hat{p}}^{2} 〉 - \frac{1}{2} ) .$$

Thereafter, the differential equations:

$${\partial }_{ϵτ} 〈 \hat{x} 〉 = 〈 \hat{u} 〉 〈 \hat{x} 〉 + ( 〈 δ \hat{x} δ \hat{u} 〉 + 〈 δ \hat{y} δ \hat{u} 〉 ) , {\partial }_{ϵτ} 〈 \hat{u} 〉 = - \frac{1}{2} {〈 \hat{x} 〉}^{2} - \frac{1}{2} ( 〈 δ {\hat{x}}^{2} 〉 - 〈 δ {\hat{y}}^{2} 〉 ) ,$$

$$\begin{matrix}{\partial }_{ϵτ} 〈 δ {\hat{x}}^{2} 〉 = 2 〈 \hat{u} 〉 〈 δ {\hat{x}}^{2} 〉 + 2 〈 \hat{x} 〉 〈 δ \hat{x} δ \hat{u} 〉 & {\partial }_{ϵτ} 〈 δ {\hat{y}}^{2} 〉 = - 2 〈 \hat{u} 〉 〈 δ {\hat{y}}^{2} 〉 + 2 ( \hat{x} ) 〈 δ \hat{y} δ \hat{v} 〉\end{matrix} ,$$

$$\begin{matrix}{\partial }_{ϵτ} 〈 δ {\hat{u}}^{2} 〉 = - 2 〈 \hat{x} 〉 〈 δ \hat{x} δ \hat{u} 〉 & {\partial }_{ϵτ} 〈 δ {\hat{v}}^{2} 〉 = - 2 〈 \hat{x} 〉 〈 δ \hat{y} δ \hat{v} 〉\end{matrix} ,$$

$${\partial }_{ϵτ} 〈 δ \hat{x} δ \hat{u} 〉 = 〈 \hat{x} 〉 ( 〈 δ {\hat{u}}^{2} 〉 - 〈 δ {\hat{x}}^{2} 〉 ) + 〈 \hat{u} 〉 〈 δ \hat{x} δ \hat{u} 〉 , \\ {\partial }_{ϵτ} 〈 δ \hat{y} δ \hat{v} 〉 = 〈 \hat{x} 〉 ( 〈 δ {\hat{v}}^{2} 〉 - 〈 δ {\hat{y}}^{2} 〉 ) - 〈 \hat{u} 〉 〈 δ \hat{y} δ \hat{v} 〉$$

with the initial conditions:

$$〈 \hat{x} 〉 ( 0 ) = \sqrt{2} 〈 \hat{q} 〉 , 〈 \hat{u} 〉 ( 0 ) = {α}_{p} ,$$

$$〈 δ {\hat{x}}^{2} 〉 ( 0 ) = 2 〈 δ {\hat{q}}^{2} 〉 , 〈 δ {\hat{y}}^{2} 〉 ( 0 ) = 2 〈 δ {\hat{p}}^{2} 〉 ,$$

$$〈 δ {\hat{u}}^{2} 〉 ( 0 ) = \frac{1}{4} , 〈 δ \hat{v} 〉 ( 0 ) = \frac{1}{4} ,$$

$$〈 δ \hat{u} δ \hat{x} 〉 ( 0 ) = 0 , 〈 δ \hat{v} δ \hat{y} 〉 ( 0 ) = 0.$$

may be solved perturbatively using Picard iteration method. In general, if

$${x}^{′ ( t )} = f ( x ( t ) )$$

the kth Picard iterate may be given by:

$${x}_{k} ( t ) = {x}_{0} + {\int }_{0}^{t} f ( ( {x}_{k - 1} ( {t}^{′} ) ) {dt}^{′}$$

where x₀ may be the initial condition, and in the limit k→∞, xₖ(t) may converge to the solution. Letting the initial values of [symbol] \hat{x} [symbol] , [symbol] δ\hat{x}² [symbol] , and [symbol] δŷ² [symbol] be denoted by x,

$${σ}_{x}^{2} , and {σ}_{y}^{2} ,$$

respectively, the first Picard iterates for the differential equations may be:

$${〈 \hat{x} 〉}_{1} = x + {ϵτα}_{P} x , {〈 \hat{u} 〉}_{1} = {α}_{P} - \frac{ϵτ}{2} {x}^{2} - \frac{ϵτ}{2} ( {σ}_{x}^{2} - {σ}_{y}^{2} ) ,$$

$${〈 δ {\hat{x}}^{2} 〉}_{1} = {σ}_{x}^{2} + 2 {ϵτα}_{P} {σ}_{x}^{2} , {〈 δ {\hat{y}}^{2} 〉}_{1} = {σ}_{y}^{2} - 2 {ϵτα}_{P} {σ}_{y}^{2} ,$$

$${〈 δ {\hat{u}}^{2} 〉}_{1} = 1 / 4 , {〈 δ {\hat{v}}^{2} 〉}_{1} = 1 / 4 ,$$

$${〈 δ \hat{x} δ \hat{u} 〉}_{1} = ϵτ x ( 1 / 4 - {σ}_{x}^{2} ) , {〈 δ \hat{y} δ \hat{v} 〉}_{1} = ϵτ x ( 1 / 4 - {σ}_{x}^{2} ) .$$

If only the terms up to [symbol] (ε) are considered, then the second Picard iterates may be:

$${( \hat{x} )}_{2} = x + ϵ {{\int }_{0}}^{τ} d {τ}^{′} ( {α}_{p} - \frac{{ϵτ}^{′}}{2} {x}^{2} - \frac{{ϵτ}^{′}}{2} ( {σ}_{x}^{2} - {σ}_{y}^{2} ) ) x + ϵ {\int }_{0}^{τ} d {τ}^{′} {ϵτ}^{′} x ( \frac{1}{2} - {σ}_{x}^{2} - {σ}_{y}^{2} ) = x + {ϵτα}_{P} x - \frac{{( ϵτ )}^{2}}{4} {x}^{3} - \frac{{( ϵτ )}^{2}}{4} x ( 3 {σ}_{x}^{2} + {σ}_{y}^{2} - 1 ) ,$$

$${( δ {\hat{x}}^{2} )}_{2} = {σ}_{x}^{2} + 2 ϵ {{\int }_{0}}^{τ} d {τ}^{′} ( {α}_{p} - \frac{{ϵτ}^{′}}{2} {x}^{2} - \frac{{ϵτ}^{′}}{2} ( {σ}_{x}^{2} - {σ}_{y}^{2} ) ) {σ}_{x}^{2} + 2 ϵ {{\int }_{0}}^{τ} d {τ}^{′} x \cdot {ϵτ}^{′} x ( \frac{1}{4} - {σ}_{x}^{2} ) = {σ}_{x}^{2} + 2 {ϵτα}_{P} {σ}_{x}^{2} - \frac{{( ϵτ )}^{2}}{2} {x}^{2} ( 3 {σ}_{y}^{2} - \frac{1}{2} ) + \frac{{( ϵτ )}^{2}}{2} ( {σ}_{x}^{2} - {σ}_{y}^{2} ) {σ}_{x}^{2} ,$$

$${( δ {\hat{y}}^{2} )}_{2} = {σ}_{y}^{2} - 2 ϵ {{\int }_{0}}^{τ} d {τ}^{′} ( {α}_{p} - \frac{{ϵτ}^{′}}{2} {x}^{2} - \frac{{ϵτ}^{′}}{2} ( {σ}_{x}^{2} - {σ}_{y}^{2} ) ) {σ}_{y}^{2} + 2 ϵ {{\int }_{0}}^{τ} d {τ}^{′} x \cdot {ϵτ}^{′} x ( \frac{1}{4} - {σ}_{y}^{2} ) = {σ}_{y}^{2} + 2 {ϵτα}_{P} {σ}_{y}^{2} - \frac{{( ϵτ )}^{2}}{2} {x}^{2} ( {σ}_{y}^{2} - \frac{1}{2} ) + \frac{{( ϵτ )}^{2}}{2} ( {σ}_{x}^{2} - {σ}_{y}^{2} ) {σ}_{y}^{2} .$$

If the original variables are substituted for the temporary notations and the solution be evaluated at τ=τₙ₁, the following extended mapping may be obtained.

$$〈 \hat{q} 〉 ↦ 〈 \hat{q} 〉 + {ϵτ}_{n 1} {α}_{p} 〈 \hat{q} 〉 - \frac{1}{8} {( {ϵτ}_{n 1} )}^{2} {〈 \hat{q} 〉}^{3} - \frac{1}{8} {( {ϵτ}_{n 1} )}^{2} 〈 \hat{q} 〉 ( 3 〈 δ {\hat{q}}^{2} 〉 + 〈 δ {\hat{p}}^{2} 〉 - 2 ) + 𝒪 ( {ϵ}^{2} ) ,$$

$$〈 δ {\hat{q}}^{2} 〉 ↦ 〈 δ {\hat{q}}^{2} 〉 + 2 {ϵτ}_{n 1} {α}_{p} 〈 δ {\hat{q}}^{2} 〉 - \frac{1}{4} {( {ϵτ}_{n 1} )}^{2} {〈 \hat{q} 〉}^{2} ( 3 〈 δ {\hat{q}}^{2} 〉 - 1 ) - \frac{1}{4} {( {ϵτ}_{n 1} )}^{2} ( 〈 δ {\hat{q}}^{2} 〉 - 〈 δ {\hat{p}}^{2} 〉 ) 〈 δ {\hat{q}}^{2} 〉 + 𝒪 ( {ϵ}^{2} ) ,$$

$$〈 δ {\hat{q}}^{2} 〉 ↦ 〈 δ {\hat{p}}^{2} 〉 - 2 {ϵτ}_{n 1} {α}_{p} 〈 δ {\hat{p}}^{2} 〉 - \frac{1}{4} {( {ϵτ}_{n 1} )}^{2} {〈 \hat{q} 〉}^{2} ( 〈 δ {\hat{p}}^{2} 〉 - 1 ) + \frac{1}{4} {( {ϵτ}_{n 1} )}^{2} ( 〈 δ {\hat{q}}^{2} 〉 - 〈 δ {\hat{p}}^{2} 〉 ) 〈 δ {\hat{p}}^{2} 〉 + 𝒪 ( {ϵ}^{2} ) .$$

The homodyne measurement may then be expanded as:

$$w = \sqrt{{R}_{o u t}} 〈 \hat{q} 〉 + \sqrt{{R}_{o u t} 〈 δ {\hat{q}}^{2} 〉 + \frac{1}{2} η ( 1 - {R}_{o u t} )} \cdot z = \sqrt{{R}_{o u t}} 〈 \hat{q} 〉 + \sqrt{\frac{1}{2} η} z + o ( ϵ ) ,$$

$$where$$

$$z ∼ 𝒩 ( 0 , 1 )$$

may be a standard normal random variable. Only the terms in the order of [symbol] may be required. Using substitution, the quantum states may be:

$$〈 \hat{q} 〉 ↦ ( 1 - \frac{1}{2} {R}_{o u t} ) 〈 \hat{q} 〉 + \sqrt{2 {η}^{- 1} {R}_{o u t}} ( 〈 δ {\hat{q}}^{2} 〉 - \frac{1}{2} η ) z + o ( {ϵ}^{\frac{3}{2}} ) ,$$

$$〈 δ {\hat{q}}^{2} 〉 ↦ 〈 δ {\hat{q}}^{2} 〉 - {R}_{o u t} ( 〈 δ {\hat{q}}^{2} 〉 - \frac{1}{2} η ) - 2 {η}^{- 1} {{R}_{o u t} ( 〈 δ {\hat{q}}^{2} 〉 - \frac{1}{2} η )}^{2} + o ( {ϵ}^{2} ) ,$$

$$〈 δ {\hat{p}}^{2} 〉 ↦ 〈 δ {\hat{p}}^{2} 〉 - {R}_{o u t} ( 〈 δ {\hat{p}}^{2} 〉 - \frac{1}{2} {η}^{- 1} ) .$$

To make the feedback injection obey the continuous time limit, a mathematical condition of f˜ε may be needed. This may be done by presupposing the form f=ƒ′Δt for some other arbitrary function ƒ′, which can be [symbol] (1). With such parameterization, the feedback 108 operation may be given by:

$$〈 \hat{q} 〉 ↦ 〈 \hat{q} 〉 + {f}^{′} △ t .$$

The above results can be put together to derive the final continuous-time Gaussian equations. For that purpose, Suzuki-Trotter theorem may be applied, according to which if there is a succession of two maps:

$$x ↦ x + {δ}_{1}$$

followed by:

$$x ↦ x + {δ}_{2}$$

with the condition:

$${δ}_{1} ∼ {δ}_{2} ∼ ϵ$$

the two maps may be combined into

$$x ↦ x + {δ}_{1} + {δ}_{2} + o ( {ϵ}^{2} )$$

As shown, the combined map may be a single map that is also correct up to order [symbol] (ε).

In addition, if there is a map:

$$x ↦ {x}^{′} + x + δ$$

a differential change

$$Δ x = {x}^{′} - x = δ x$$

may be defined.

### Furthermore, if

$$δ x ∼ Δ t$$

a derivative may be constructed via

$$d x / d t = {lim}_{Δ t \to 0} \frac{Δ x}{Δ t} ∼ o ( 1 )$$

Using the above, the final differential equations may be:

$$\frac{d x}{d t} = - ( γ + κ ) x + p x - χ {x}^{3} + {f}^{′} - χ x ( 3 {σ}^{2} + {ς}^{2} - 2 ) + 2 \sqrt{κ {η}^{- 1}} ( {σ}^{2} - \frac{1}{2} η ) ξ ,$$

$$\frac{d {σ}^{2}}{d t} = - 2 γ ( {σ}^{2} - \frac{1}{2} ) - 2 κ ( {σ}^{2} - \frac{1}{2} η ) + 2 p {σ}^{2} - 2 χ {x}^{2} ( 3 {σ}^{2} - 1 ) - 2 χ ( {σ}^{2} - {ς}^{2} ) {σ}^{2} - 4 κ {{η}^{- 1} ( {σ}^{2} - \frac{1}{2} η )}^{2} ,$$

$$\frac{{dς}^{2}}{d t} = - 2 γ ( {ς}^{2} - \frac{1}{2} ) - 2 κ ( {ς}^{2} - \frac{1}{2} {η}^{- 1} ) - 2 p {ς}^{2} - 2 χ {x}^{2} ( {ς}^{2} - 1 ) + 2 χ ( {σ}^{2} - {ς}^{2} ) {ς}^{2} .$$

where,

$$x = 〈 \hat{q} 〉 ,$$

$${σ}^{2} = 〈 δ {\hat{q}}^{2} 〉 ,$$

$${ς}^{2} = 〈 δ {\hat{p}}^{2} 〉 .$$

Therefore, the continuous time quantities may be described in terms of the corresponding discrete time quantities as follows:

$$γ = \frac{{R}_{l o s s}}{Δ t} , κ = \frac{{R}_{out}}{2 Δ t} , p = \frac{ϵ {τ}_{n 1}}{Δ t} {α}_{ρ} , x = \frac{{( ϵ {τ}_{n 1} )}^{2}}{8 Δ t} , ξ = \frac{z}{\sqrt{Δ t}} .$$

Comparing this against the classical formulation described above, all the terms are covered. Additionally, γ+κ may be lumped together into single γ. Additionally, f may be chosen for a correct coupling term, detailed below, while the new fifth and sixth terms are quantum mechanical terms. The fifth term may indicate that quantum uncertainties σ² and [symbol] may couple into the dynamics of x through a nonlinear interaction (although if x>>σ², [symbol] , these parameters can largely be ignored). The sixth term may be a random noise term describing a specific kind of “Brownian motion,” because by construction,

$$〈 ξ ( t ) ξ ( {t}^{′} ) 〉 = δ ( t - {t}^{′} )$$

i.e., an ensemble average taken over draws of the random variable z may formally define a Gaussian white-noise process, and in this context, this term may describe the quantum backaction of the homodyne measurement within the controller 104. And the existence of dynamical quantum uncertainties may be entirely quantum-mechanical effects inherent to the constructed physical system.

Furthermore, it is to be understood that although the equations of motion have been derived that realize the classical formulation of CIM 100 in certain limits (with additional quantum mechanical features), the spin variable xᵢ may not be accessible (i.e., due to the noisy measurement). The degree of freedom that has been identified may be [symbol] \hat{q} [symbol] , i.e., the expected value of an internal quantum state of an oscillator within the process cavity 102. This expected value may be different from what is measured and recorded in the controller 104. This noisiness and uncertainty may have major implications for how feedback is performed to compute the coupling term fᵢ as well as how the dynamics of the auxiliary variables eᵢ is generated.

The measurement outcome may be given by stochastic outcome at the homodyne receivers of the controller 104. The stochastic outcome reflecting that quantum-mechanical measurements may be random in nature and may not allow a perfect knowledge of physical state. Therefore, an estimated amplitude may be generated as follows:

$${\tilde{x}}_{i} = \frac{{w}_{i}}{\sqrt{{R}_{out}}} = x + \sqrt{\frac{η}{2 {R}_{out}} + {σ}_{i}^{2} - \frac{1}{2} η \cdot z} ,$$

which may provide an access to x with some corruption by a noisy term. The controller 104 may then compute:

$${f}_{i}^{′} = {e}_{i} {\sum }_{j = 1}^{N} {J}_{ij} {\tilde{x}}_{j} ,$$

$$\frac{{de}_{i}}{dt} = - β ( {\tilde{x}}_{i}^{2} - {μ}^{2} ) {e}_{i} ,$$

The above described controller 104 procedure may be sufficient if x is large compared to the second noise term. However, in the continuous time-limit-which may be necessary to obtain differential equations implementing the canonical formulation of the CIM 100—the portion of interest is in the limit Rₒᵤₜ→0, which may imply that the noise term diverges and becomes infinite. Although the computations may be initially unaffected, they may gradually become non-performant and completely fail, essentially due to the divergence.

In the continuous time limit where Rₒᵤₜ→0, the feedback

$${f}_{i}^{′}$$

may be formulated as:

$${f}_{i}^{′} = {e}_{i} {\sum }_{j = 1}^{N} {J}_{ij} {x}_{j} + {e}_{i} {\sum }_{j = 1}^{N} {J}_{ij} \sqrt{\frac{η}{4 κ}} {ξ}_{j} ,$$

after expanding to [symbol] (ε) and using the equivalence definitions between continuous time and discrete time. The feedback may therefore become another quantum white noise term, similar to the term describing backaction noise. The difference may be that the above expression represents a re-injected noise from measurement 106 back into the process cavity 102 through the system feedback 108. That is, this expression may show coupling of noise from different spins through the Ising problem matrix in the process cavity 102. Therefore, the noisy quantum measurements may not be an issue for linear feedback terms, which may be the nature of

$${f}_{i}^{′} .$$

Rather, the more problematic part may be chaotic amplitude control equation, which is analyzed now. For a single roundtrip lasting time Δt, the chaotic amplitude control equation may provide that the variables eᵢ may be updated according to:

$$\frac{Δ {e}_{i}}{Δ t} = - β {e}_{i} [ ( {x}_{i}^{2} - {μ}^{2} ) + \sqrt{\frac{η}{4 κ}} {x}_{i} {ξ}_{i} + ( \frac{η}{4 κΔ t} + ( {σ}_{i}^{2} - \frac{1}{2} η ) ) {z}_{i}^{2} + 𝒪 ( Δ {t}^{\frac{1}{2}} ) ] .$$

In the above equation, the second term is a stochastic noise term. Additionally, there is an extraneous non-stochastic term and a noise term that diverges in the limit Δt→0.

The problem at hand, therefore, may be that the equations of motion for:

$${x}_{i} = 〈 \hat{q} 〉$$

may be expressed in terms of quantum state, but there may be no direct access to the quantum state in the physical cavity 102 through the measurement 106. This situation, however, may be analogized to a problem of noisy estimation, where there is a black box (i.e., the physical cavity 102) with some internal state, and there are only noisy observations (i.e., made by the controller 104) of some aspects of the state. The noise in the physical cavity 102 may be due to quantum uncertainty rather than classical ignorance, but these two problems may be similar. For instance, in a classical setting, control signals may be applied to the black box in order to steer the internal state to some desired configuration. The solution then may be to introduce an estimator of the state on the side of the controller. Starting with the known initial condition, as noisy measurements are made, an up-to-date twin of the internal state is kept to the best of the controller's ability, using statistical methods like maximum likelihood and least squares to make optimal inferences about the perturbations that the internal system is subjected to. An analogous process may be applied on the CIM 100.

The generic scenario for optimal linear estimation may be a linear system driven by inputs and by a Gaussian process noise:

$$dx = Axdt + Budt + FdW$$

Linear observations of the system with the Gaussian measurement noise may also be considered:

$$dz = Cxdt + GdV .$$

A correlation between process noise and measurement noise may be allowed. The correlation may be captured by:

$$Γ dt = G ( {dVdW}^{T} ) {F}^{T}$$

Under these conditions, an optimal estimate of the state variable x may be given by:

$$d \tilde{x} = A \tilde{x} dt + Budt + ( ε {C}^{T} + {Γ}^{T} ) {( {GG}^{T} )}^{- 1} ( dz - C \tilde{x} dt )$$

where ε may be the covariance matrix of the estimation error, which may evolve according to:

$$\frac{d ε}{dt} = A ε + ε {A}^{T} + {FF}^{T} - ( ε {C}^{T} + {Γ}^{T} ) {( {GG}^{T} )}^{- 1} ( C ε + Γ )$$

Because the Kalman filter is formulated for linear system (with possibility of nonlinear feedback functions), an assumption may be first made that CIM 100 does not have an optical nonlinearity. This can be done by assuming that

$$p ≪ k + γ$$

so the CIM 100 may be far below the threshold and

$$χ {x}^{2} ≪ 1$$

In such situations, the equation for imaginary quadrature may decouple from other equations and become irrelevant. In such linear regime, the equations of motion from the CIM 100 may simplify to:

$${dx}_{i} = ( p - κ - γ ) {x}_{i} dt + {f}_{i}^{′} dt + 2 \sqrt{{κη}^{- 1}} ( {σ}_{i}^{2} - \frac{1}{2} η ) {dW}_{i} ,$$

$$\frac{d {σ}_{i}^{2}}{dt} = 2 p {σ}_{i}^{2} - 2 γ ( {σ}_{i}^{2} - \frac{1}{2} ) - 2 κ ( {σ}_{i}^{2} - \frac{1}{2} η ) - 4 {{κη}^{- 1} ( {σ}_{i}^{2} - \frac{1}{2} η )}^{2} .$$

### Here,

$$d {W}_{i} = {ξ}_{i} d t$$

may be the increment of a white-noise process. Therefore, the measurement 106 may be reformulated as:

$$d z = {lim}_{Δ t \to 0} {w}_{i} \sqrt{Δ t}$$

In continuous time-limit, the above becomes a stochastic process, given by:

$$d {z}_{i} = \sqrt{2 κ} {x}_{i} dt + \sqrt{\frac{1}{2} η} {dW}_{i}$$

From this, in terms of general Kalman filter, the following expressions may be obtained:

$${A}_{i j} = ( p - κ - γ ) {δ}_{i j}$$

$${( Bu )}_{i} = {f}_{i}^{′}$$

$${C}_{i j} = \sqrt{2 κ} {δ}_{i j}$$

$${F}_{i j} = 2 \sqrt{κ {η}^{- 1}} ( {σ}_{i}^{2} - \frac{1}{2} η ) {δ}_{ij}$$

$${G}_{i j} = \sqrt{\frac{1}{2} η} {δ}_{ij}$$

$${Γ}_{i j} = \sqrt{2 κ} ( {σ}_{i}^{2} - \frac{1}{2} η ) {δ}_{i j}$$

which may result in the following filter equations of motion:

$$d {\tilde{x}}_{i} = ( p - κ - γ ) {\tilde{x}}_{i} dt + {f}_{i}^{′} dt + 2 {η}^{- 1} \sqrt{2 κ} ( {ϵ}_{i}^{2} + {σ}_{i}^{2} - \frac{1}{2} η ) ( d {z}_{i} - \sqrt{2 κ} {\tilde{x}}_{i} dt )$$

$$\frac{d {ϵ}_{i}^{2}}{d t} = 2 ( p - κ - γ ) {ϵ}_{i}^{2} + 4 {η}^{- 1} {κ ( {σ}_{i}^{2} - \frac{1}{2} η )}^{2} - 4 {η}^{- 1} {κ ( {ϵ}_{i}^{2} + {σ}_{i}^{2} - \frac{1}{2} η )}^{2}$$

From the above, it can be observed that if the initial condition satisfies:

$${\tilde{x}}_{i} = {x}_{i}$$

and there is no initial uncertainty, i.e.,

$${ϵ}_{i}^{2} = 0$$

then,

$$d {ϵ}_{i}^{2} = 0$$

for all the time, the estimation may be perfect. That is, even though there is access to only the noise data in dzᵢ, zᵢ(t) may be used to calculate \tilde{x}_{ι}, which may effectively filter noisy signal zᵢ(t) to produce an estimate \tilde{x}_{ι}(t). In such ideal case, the filter may provide \tilde{x}_{ι}=xᵢ. Because, \tilde{x}_{ι} is now defined, this estimate can be used in the controller 104.

Under ideal conditions, the only noise in the CIM 100 may be the noise observed by the controller 104, which may be correlated between the backaction and measurement 106. That is, if there is no excess process noise within the CIM 100, a state estimation may be performed by an estimated state of the process cavity 102 and simulating the dynamics and the measurement 106 process. Such estimation may be used in the cases where dynamics may occur in discrete time (i.e., when Δt may be finite and not small enough) and when nonlinear saturation is appreciable (i.e., all terms associated with nonlinear coefficient x are non-negligible). The procedure may be outlined as follows.

An estimate
[symbol] of the state of the process cavity 102 in a previous iteration may be taken as a starting point, assuming that the estimate is optimal. Here the generic symbol

$$\vert ψ 〉$$

is used to indicate that the scheme is general. However, estimate can be the above set of variables

$$\{ \tilde{x} , \}$$

### if the CIM 100 is Gaussian.

The dynamics of the CIM 100 may be simulated based on the above state. For example, the simulation may include, for example, linear loss, crystal propagation, and/or linear loss to simulate propagation through the lossy nonlinear crystal. If the CIM 100 is Gaussian and discrete time, the Gaussian discrete time equations may be used. However, more general quantum models may be used as well.

A physical measurement 106 may be made on the process cavity 102 and the measurement may be recorded. In case of the discrete time Gaussian model, the measurement would correspond to random measurement w but not generated by random variables. Instead, it may be random output of the quantum mechanics in the process cavity 102. The measurement 106 may then be compared against the expected result.

The difference may be referred to as an “innovation term” in the language of Kalman filtering and may be equivalent to terms

$$ω - 〈 \hat{q} m 〉 or$$

$${dz}_{i} - \sqrt{2 κ} {\tilde{x}}_{i} d t$$

described above. The innovation term may allow to solve for the random noise imparted by the quantum mechanics in the process cavity 102. That is, the controller 104 may know what it was expecting because the state had already been estimated. But a random result [symbol] was received. The difference between the expectation and the random result may be the unknown effect of quantum uncertainty. So long as there is no other process noise or other uncertainty in the system, this procedure may be performed without loss of information despite the randomness of the measurement process.

Using the known value of noise that was introduced by the measurement 106, a feedback 108 on the system state

$$\vert ψ 〉$$

may be imparted. The effect of the feedback 108 may be duplicated by simulating the feedback on the estimated state

$$\vert \tilde{ψ} 〉 .$$

The controller 104 may then calculate the exact feedback 108 to be applied to the process cavity 102. Although the controller 104 may not have access to the state

$$\vert ψ 〉 ,$$

the above procedure may provide a high-fidelity copy in the form of the estimated state

$$\vert \tilde{ψ} 〉 .$$

This estimated state may be used calculate the feedback 108. For example, the feedback 108 may be based on chaotic amplitude control variables and the Ising coupling.

The above process may work for any quantum system for which the internal dynamics is known and where there is no excess process noise.

Additionally, it may be possible to perform a simplified quantum state estimation, where the simulation can be used to obtain the estimated state that is known to be less accurate than the process cavity 102. This simple estimation may be useful when there is some robustness in the less than perfect estimate, i.e., if the starting point is close enough to the actual state and the feedback 108 applied is based on the close enough estimate, the estimated state may not be too far from the actual state in the process cavity 102. The simple estimation may be particularly useful when it may be difficult to simulate the full physical properties of the process cavity 102, e.g., because quantum dynamics may be hard to simulate. In these cases, if the quantum system in the process cavity 102 is within reasonable bounds, then a Gaussian approximation of non-Gaussian dynamics may suffice to generate the estimated state that is useful for calculating and performing the feedback 108.

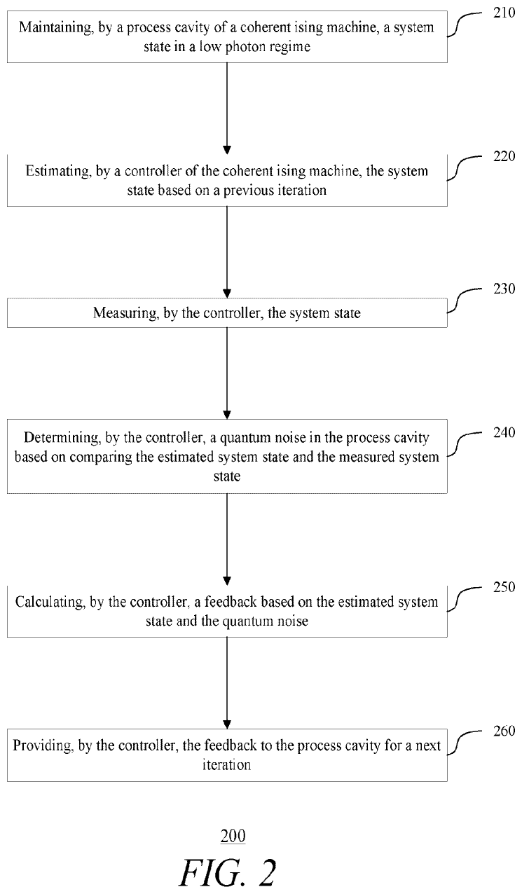

FIG. 2 is a flowchart of an example method 200 for executed by a CIM, according to example embodiments of this disclosure. The steps of the method 200 are just examples and methods with additional, alternative, or fewer number of steps should be considered within the scope this disclosure.

The method may begin at step 210, where a process cavity of the CIM may maintain a system state in a low photon regime. The system state may represent a state of a combinatorial optimization problem and a plurality of optical oscillators within the CIM may store individual spins associated with the combinatorial optimization problem.

At step 220, a controller of the CIM may estimate the system state of the process cavity based on a previous iteration. Such estimation may be based on a known, deterministic initial state of the process cavity. Additionally or alternatively, the estimation may be based on simulating physical dynamics on a previous state associated with the previous iteration.

At step 230, the controller may measure the system state. This may be an actual, albeit noisy, measurement made by the controller.

At step 240, the controller may determine a quantum noise in the process cavity based on comparing the estimated system state and the measured system state. That is, the measured system state may be a random variable and the difference between this random variable and the estimated state may represent the quantum noise in the process cavity.

At step 250, the controller may calculate a feedback based on the estimated system state and the quantum noise. That is, the feedback may be taken into account in both the estimated system state and the actual measurement.

At step 260, the controller may provide the feedback to the process cavity for a next iteration. The iterations may continue until an optimal combination—i.e., solution to the Ising problem—is found.

Additional examples of the presently described method and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A coherent Ising machine comprising:
a process cavity configured maintain a system state in a low photon regime; and
a controller configured to:
estimate the system state based on a previous iteration;
measure the system state;
determine a quantum noise in the process cavity based on comparing the estimated system state and the measured system state;
calculate a feedback based on the estimated system state and the quantum noise; and
provide the feedback to the process cavity for a next iteration.

2. The coherent Ising machine of claim 1, wherein the controller is further configured to estimate the system state based on information about an initial system state.

3. The coherent Ising machine of claim 1, wherein the controller is further configured to estimate the system state by simulating physical system dynamics on a previous system state of the previous iteration.

4. The coherent Ising machine of claim 3, wherein the physical system dynamics comprise at least one of a linear loss and crystal propagation.

5. The coherent Ising machine of claim 1, wherein the controller is further configured to:
simulate a measurement on the estimated system state; and
calculate the feedback based on the simulated measurement.

6. The coherent Ising machine of claim 1, wherein the controller is further configured to:
calculate the feedback based on applying chaotic amplitude control.

7. The coherent Ising machine of claim 1, wherein the feedback is nonlinear.

8. The coherent Ising machine of claim 1, the controller comprising a field programmable gate array.

9. The coherent Ising machine of claim 1, the controller comprising a digital computer.

10. The coherent Ising machine of claim 1, the process cavity comprising a plurality of optical oscillators configured to store individual spins associated with a combinatorial optimization problem.

11. A method comprising:
maintaining, by a process cavity of a coherent Ising machine, a system state in a low photon regime;
estimating, by a controller of the coherent Ising machine, the system state based on a previous iteration;
measuring, by the controller, the system state;
determining, by the controller, a quantum noise in the process cavity based on comparing the estimated system state and the measured system state;
calculating, by the controller, a feedback based on the estimated system state and the quantum noise; and
providing, by the controller, the feedback to the process cavity for a next iteration.

12. The method of claim 11, further comprising:
estimating, by the controller, the system state based on information about an initial system state.

13. The method of claim 11, further comprising:
estimating, by the controller, the system state by simulating physical system dynamics on a previous system state of the previous iteration.

14. The method of claim 13, wherein the physical system dynamics comprise at least one of a linear loss and crystal propagation.

15. The method of claim 11, further comprising:
simulating, by the controller, a measurement on the estimated system state; and
calculating, by the controller, the feedback based on the simulated measurement.

16. The method of claim 11, further comprising:
calculating, by the controller, the feedback based on applying chaotic amplitude control.

17. The method of claim 11, wherein the feedback is nonlinear.

18. The method of claim 11, the controller comprising a field programmable gate array.

19. The method of claim 11, the controller comprising a digital computer.

20. The method of claim 11, further comprising:
storing, by a plurality of optical oscillators of the process cavity, individual spins associated with a combinatorial optimization problem.
